(19) United States
(12) Patent Application Publication
(10) Pub. No.: US 2017/0166750 A1
(43) Pub. Date: Jun. 15, 2017

(54) HARDCOATS COMPRISING ALKOXYLATED MULTI (METH)ACRYLATE MONOMERS

(71) Applicant: 3M INNOVATIVE PROPERTIES COMPANY, St. Paul, MN (US)

(72) Inventors: Richard J. Pokorny, Maplewood, MN (US); Steven D. Solomonson, Shoreview, MN (US); Robert F. Kamrath, Mahtomedi, MN (US); Anthony M. Renstrom, Forest Lake, MN (US); Roger W. Barton, Afton, MN (US); Craig R. Sykora, New Richmond, WI (US)

(21) Appl. No.: 15/441,600

(22) Filed: Feb. 24, 2017

Related U.S. Application Data
(62) Division of application No. 14/404,970, filed on Dec. 2, 2014.
(60) Provisional application No. 61/783,509, filed on Mar. 14, 2013.
(60) Provisional application No. 61/703,400, filed on Sep. 20, 2012.
(60) Provisional application No. 61/671,354, filed on Jul. 13, 2012.

(51) Int. Cl. C09D 4/00; C09D 7/12

(52) U.S. Cl. CPC C09D 4/00; C09D 7/1266; C09D 7/1216; C08K 3/36

(57) ABSTRACT

Presently described are hardcoat compositions comprising at least one first (meth)acrylate monomer comprising at least three (meth)acrylate groups and C₂-C₄ alkoxy repeat units wherein the monomer has a molecular weight per (meth)acrylate group ranging from about 220 to 375 g/mole and at least one second (meth)acrylate monomer comprising at least three (meth)acrylate groups. In one embodiment, the hardcoat composition further comprises and at least 50 wt-% solids of silica nanoparticles. Also described are articles, such as protective films, displays, and touch screens comprising such cured hardcoat compositions.

### CROSS REFERENCE TO RELATED APPLICATIONS

This application is a divisional application of U.S. patent application Ser. No. 14/404,970, filed Dec. 2, 2014, which is a 371 of International PCT/US2013/049859, filed Jul. 10, 2013, which claims priority to U.S. Provisional Application No. 61/783,509, filed Mar. 14, 2013; U.S. Provisional Application No. 61/703,400, filed Sep. 20, 2012 and U.S. Provisional Application No. 61/671,354, filed Jul. 13, 2012, the disclosures of which are incorporated herein by reference in its entirety.

### SUMMARY

Presently described are hardcoat compositions comprising at least one first (meth)acrylate monomer comprising at least three (meth)acrylate groups and C₂-C₄ alkoxy repeat units wherein the monomer has a molecular weight per (meth)acrylate group ranging from about 220 to 375 g/mole and at least one second (meth)acrylate monomer comprising at least three (meth)acrylate groups. In one embodiment, the hardcoat composition further comprises and at least 30 wt-% solids of silica nanoparticles having an average particle size ranging from 50 to 150 nm. In another embodiment, the hardcoat composition further comprises and at least 30 wt-% solids of inorganic oxide nanoparticles having an average particle size ranging from 50 to 150 nm.

Also described are articles, such as protective films and displays, comprising such cured hardcoat compositions.

### BRIEF DESCRIPTION OF THE DRAWINGS

FIG. 1 is a cross-sectional schematic of a touch screen;

FIG. 2 is a cross-sectional schematic of a touch sensor substrate; and

FIG. 3 is a cross-sectional schematic of a touch screen bonded to an illuminated display.

### DETAILED DESCRIPTION

The present invention pertains to hardcoat compositions comprising a polymerizable resin composition and inorganic oxide nanoparticles, as well as articles such as protective films and (e.g. illuminated) displays comprising such cured hardcoat. In favored embodiments, the hardcoat approaches the properties of glass, having high transparency, low haze, and high durability.

The polymerizable resin composition comprises at least one first (meth)acrylate monomer comprising at least three (meth)acrylate groups and alkoxy (i.e. alkylene oxide) repeat units. The alkoxy (i.e. alkylene oxide) repeat units typically have the formula —[O-L]- wherein L is a linear or branched alkylene. In some embodiments, the alkylene is a linear or branched C₂-C₆ alkylene. Such monomers may be represented by the general formula:

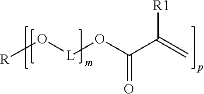

wherein R1 is H or methyl, R is a trivalent organic residue; for each m, L is independently a straight-chain or branched C₂ to C₆ alkylene; and for each p, m is independently at least 1, 2 or 3 3 and no greater than 30 or 25. In some embodiments, m is no greater than 20, or 15, or 10.

In some embodiments, the first (meth)acrylate monomer comprises linear alkoxy repeat units such as ethylene oxide repeat units. Such monomers may be represented by the general formula:

R((OCₙH₂ₙ)ₘOC(O)C(R⁶)═CH₂)ₚ

wherein R is an organic residue having a valency of p, n is the number of carbon atoms of the alkoxy repeat unit, m is the number of alkoxy repeat units, R⁶ is hydrogen or methyl, and p is at least 3. For each m, n can independently range from 1 to 4. In some embodiments, the number of alkoxy repeat units, m, is greater than 6 and typically less than 20. In some embodiments, p is at least 4, or 5, or 6. In some embodiments, R is a hydrocarbon residue, optionally further comprising one or more oxygen, sulfur or nitrogen atoms. In some embodiments, R comprises at least 3, 4, 5, or 6 carbon atoms and typically no greater than 12 carbon atoms.

In other embodiments, the first (meth)acrylate monomer comprises branched alkoxy repeat units such as isopropylene oxide and/or isobutylene oxide repeat units. Some embodied monomers may be represented by the general formula:

R((OCₙ(CH₃)_{q}H_{2n-q})ₘOC(O)—C(R⁶)═CH₂)ₚ

wherein R and p are the same a previously described. In the case of branched isopropylene oxide repeat units, n is 2 and q is 1. In the case of branched isobutylene oxide repeat units, n is 2 and q is 2.

The first (meth)acrylate monomer comprising at least three (meth)acrylate groups and C₂-C₄ alkoxy repeat units may comprises any combination of linear and/or branched C₂-C₄ alkoxy repeat units. Thus, the first (meth)acrylate monomer may comprise solely ethylene oxide repeat units, solely propylene oxide repeat units, solely butylene oxide repeat units, as well as combinations thereof In one embodiment, the first (meth)acrylate monomer comprises a combination of both ethylene oxide and propylene oxide repeat units.

In favored embodiments, the molecular weight of the first (meth)acrylate monomer divided by the number of (meth)acrylate groups ranges from about 220 to 375 g/mole. Or in other words, the molecular weight per (meth)acrylate group ranges from about 220 to 375 g/mole per (meth)acrylate. As is demonstrated in the forthcoming examples, inclusion of such first (meth)acrylate monomer is amenable to providing a glass-like hardcoat. In some embodiments, the cured hardcoat (at a thickness of at least 10 microns) exhibits no cracking when tested with a #7H pencil and a 750 gram load. Alternatively or in addition thereof, the cured hardcoat is sufficiently durable such that it exhibits a haze of less than 5, or 4, or 3, or 2% after abrasion testing (according to the test method described in the examples).

Properties of commercially available ethoxylated trimethylolpropane triacrylate monomers that meet such criteria, include for example SR9035 and SR502, available from Sartomer as further described in the forthcoming examples. Other monomers that meet such criteria can be synthesized, such as by reaction of polyalkylene oxide polyols with acrylic acid, as also described in the forthcoming example.

The concentration of the first(meth)acrylate monomer in the cured hardcoat composition is typically at least 5 wt-% or 10 wt-% solids and generally no greater than 40 wt-%, or 35 wt-%, or 30 wt-%, or 25 wt-% solids. In some embodiments, the concentration of the first monomer is at least 11, 12, 13, 14, or 15 wt-% solids. In some embodiments, the concentration of the first monomer is no greater than 24, 23, 22, 21, or 20 wt-% solids.

The polymerizable resin of the hardcoat composition comprises at least one second multi-(meth)acrylate monomer. The second (meth)acrylate monomer is a different monomer than the first monomer.

Useful multi-(meth)acrylate monomers and oligomers include:

(a) di(meth)acryl containing monomers such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated bisphenol A diacrylate, hydroxypivalaldehyde modified trimethylolpropane diacrylate, neopentyl glycol diacrylate, polyethylene glycol diacrylate, propoxylated neopentyl glycol diacrylate, tetraethylene glycol diacrylate, tricyclodecanedimethanol diacrylate, triethylene glycol diacrylate, tripropylene glycol diacrylate;

(b) tri(meth)acryl containing monomers such as glycerol triacrylate, trimethylolpropane triacrylate, ethoxylated triacrylates (e.g., ethoxylated trimethylolpropane triacrylate), propoxylated triacrylates (e.g., propoxylated glyceryl triacrylate, propoxylated trimethylolpropane triacrylate), trimethylolpropane triacrylate, tris(2-hydroxyethyl)isocyanurate triacrylate;

(c) higher functionality (meth)acryl containing monomer such as ditrimethylolpropane tetraacrylate, dipentaerythritol pentaacrylate, pentaerythritol triacrylate, ethoxylated pentaerythritol tetraacrylate, and caprolactone modified dipentaerythritol hexaacrylate.

Oligomeric (meth)acryl monomers such as, for example, urethane acrylates, polyester acrylates, and epoxy acrylates can also be employed.

Such (meth)acrylate monomers are widely available from vendors such as, for example, Sartomer Company of Exton, Pa.; Cytec Industries of Woodland Park, N; and Aldrich Chemical Company of Milwaukee, Wis.

In some embodiments, the hardcoat composition comprises (e.g. solely) a crosslinking agent as the second (meth)acrylate monomer comprising at least three (meth)acrylate functional groups. In some embodiments, the second crosslinking monomer comprises at least four, five or six (meth)acrylate functional groups. Acrylate functional groups tend to be favored over (meth)acrylate functional groups.

Preferred commercially available crosslinking agent include for example trimethylolpropane triacrylate (commercially available from Sartomer Company, Exton, Pa. under the trade designation “SR351”), ethoxylated trimethylolpropane triacrylate (commercially available from Sartomer Company, Exton, Pa. under the trade designation “SR454”), pentaerythritol tetraacrylate, pentaerythritol triacrylate (commercially available from Sartomer under the trade designation “SR444”), dipentaerythritol pentaacrylate (commercially available from Sartomer under the trade designation “SR399”), ethoxylated pentaerythritol tetraacrylate, ethoxylated pentaerythritol triacrylate (from Sartomer under the trade designation “SR494”), dipentaerythritol hexaacrylate, and tris(2-hydroxy ethyl) isocyanurate triacrylate (from Sartomer under the trade designation “SR368”.

In some embodiments, the second (e.g. crosslinking) monomer does not comprise C₂-C₄ alkoxy repeat units.

The concentration of the total amount of second monomer(s) in the cured hardcoat composition is typically at least 10 wt-%, or 15 wt-%, or 20 wt-% solids and generally no greater than 50 wt-%, or 45 wt-%, or 40 wt-% solids.

In other embodiments, the hardcoat composition may comprise at blend of two or more monomers such as a crosslinking agent (e.g. lacking C₂-C₄ alkoxy repeat units) comprising at least three (meth)acrylate functional groups and at least one di(meth)acrylate monomer or oligomer. The concentration of the di(meth)acrylate monomer or oligomer is typically no greater than 15, or 10, or 5 wt-% solids of the total hardcoat composition.

The hardcoat composition comprises surface modified inorganic oxide particles that add mechanical strength and durability to the resultant coating. The particles are typically substantially spherical in shape and relatively uniform in size. The particles can have a substantially monodisperse size distribution or a polymodal distribution obtained by blending two or more substantially monodisperse distributions. The inorganic oxide particles are typically non-aggregated (substantially discrete), as aggregation can result in precipitation of the inorganic oxide particles or gelation of the hardcoat. The size of inorganic oxide particles is chosen to avoid significant visible light scattering. The hard coat composition generally comprises a significant amount of surface modified inorganic oxide nanoparticles having an average (e.g. unassociated) primary particle size or associated particle size of at least 30, 40 or 50 nm and no greater than about 150 nm. When the hardcoat composition lacks a significant amount of inorganic nanoparticles of such size, the cured hardcoat can crack when subjected to the pencil hardness test described herein. The total concentration of inorganic oxide nanoparticles is typically a least 30, 35, or 40 wt-% solids and generally no greater than 70 wt-%, or 65 wt-%, or 60 wt-% solids.

The hardcoat composition may comprise up to about 10 wt-% solids of smaller nanoparticles. Such inorganic oxide nanoparticles typically having an average (e.g. unassociated) primary particle size or associated particle size of at least 1 nm or 5 nm and no greater than 50, 40, or 30 nm.

The average particle size of the inorganic oxide particles can be measured using transmission electron microscopy to count the number of inorganic oxide particles of a given diameter. The inorganic oxide particles can consist essentially of or consist of a single oxide such as silica, or can comprise a combination of oxides, or a core of an oxide of one type (or a core of a material other than a metal oxide) on which is deposited an oxide of another type. Silica is a common inorganic particle utilized in hardcoat compositions. The inorganic oxide particles are often provided in the form of a sol containing a colloidal dispersion of inorganic oxide particles in liquid media. The sol can be prepared using a variety of techniques and in a variety of forms including hydrosols (where water serves as the liquid medium), organosols (where organic liquids so serve), and mixed sols (where the liquid medium contains both water and an organic liquid).

Aqueous colloidal silicas dispersions are commercially available from Nalco Chemical Co., Naperville, Ill. under the trade designation “Nalco Collodial Silicas” such as products 1040, 1042, 1050, 1060, 2327, 2329, and 2329K or Nissan Chemical America Corporation, Houston, Tex. under the trade name Snowtex™. Organic dispersions of colloidal silicas are commercially available from Nissan Chemical under the trade name Organosilicasol™. Suitable fumed silicas include for example, products commercially available from Evonki DeGussa Corp., (Parsippany, N.J.) under the trade designation, “Aerosil series OX-50”, as well as product numbers -130, -150, and -200. Fumed silicas are also commercially available from Cabot Corp., Tuscola, Ill., under the trade designations CAB-O-SPERSE 2095”, “CAB-O-SPERSE A105”, and “CAB-O-SIL M5”.

It may be desirable to employ a mixture of inorganic oxide particle types to optimize an optical property, material property, or to lower that total composition cost.

As an alternative to or in combination with silica the hardcoat may comprise various high refractive index inorganic nanoparticles. Such nanoparticles have a refractive index of at least 1.60, 1.65, 1.70, 1.75, 1.80, 1.85, 1.90, 1.95, 2.00 or higher. High refractive index inorganic nanoparticles include for example zirconia (“ZrO₂”), titania (“TiO₂”), antimony oxides, alumina, tin oxides, alone or in combination. Mixed metal oxide may also be employed.

Zirconias for use in the high refractive index layer are available from Nalco Chemical Co. under the trade designation “Nalco OOSSOO8”, Buhler AG Uzwil, Switzerland under the trade designation “Buhler zirconia Z-WO sol” and Nissan Chemical America Corporation under the trade name NanoUse ZR™. Zirconia nanoparticles can also be prepared such as described in U.S. Patent Publication No. 2006/0148950 and U.S. Pat. No. 6,376,590. A nanoparticle dispersion that comprises a mixture of tin oxide and zirconia covered by antimony oxide (RI˜1.9) is commercially available from Nissan Chemical America Corporation under the trade designation “HX-05M5”. A tin oxide nanoparticle dispersion (RI˜2.0) is commercially available from Nissan Chemicals Corp. under the trade designation “CX-S401M”. Zirconia nanoparticles can also be prepared such as described in U.S. Pat. No. 7,241,437 and U.S. Pat. No. 6,376,590.

The inorganic nanoparticles of the hardcoat are preferably treated with a surface treatment agent. Surface-treating the nano-sized particles can provide a stable dispersion in the polymeric resin. Preferably, the surface-treatment stabilizes the nanoparticles so that the particles will be well dispersed in the polymerizable resin and results in a substantially homogeneous composition. Furthermore, the nanoparticles can be modified over at least a portion of their surface with a surface treatment agent so that the stabilized particle can copolymerize or react with the polymerizable resin during curing. The incorporation of surface modified inorganic particles is amenable to covalent bonding of the particles to the free-radically polymerizable organic components, thereby providing a tougher and more homogeneous polymer/particle network.

In general, a surface treatment agent has a first end that will attach to the particle surface (covalently, ionically or through strong physisorption) and a second end that imparts compatibility of the particle with the resin and/or reacts with resin during curing. Examples of surface treatment agents include alcohols, amines, carboxylic acids, sulfonic acids, phosphonic acids, silanes and titanates. The preferred type of treatment agent is determined, in part, by the chemical nature of the metal oxide surface. Silanes are preferred for silica and other for siliceous fillers. Silanes and carboxylic acids are preferred for metal oxides such as zirconia. The surface modification can be done either subsequent to mixing with the monomers or after mixing. It is preferred in the case of silanes to react the silanes with the particle or nanoparticle surface before incorporation into the resin. The required amount of surface modifier is dependent upon several factors such as particle size, particle type, modifier molecular wt, and modifier type. In general, it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for from 1-24 hr approximately. Surface treatment agents such as carboxylic acids may not require elevated temperatures or extended time.

In some embodiments, inorganic nanoparticle comprises at least one copolymerizable silane surface treatment. Suitable (meth)acryl organosilanes include for example (meth)acryloy alkoxy silanes such as 3-(methacryloyloxy)propyltrimethoxysilane, 3-acryloylxypropyltrimethoxysilane, 3-(methacryloyloxy)propylmethyldimethoxysilane, 3-(acryloyloxypropyl)methyl dimethoxysilane, 3-(methacryloyloxy)propyldimethylmethoxysilane, and 3-(acryloyloxypropyl) dimethylmethoxysilane. In some embodiments, the (meth)acryl organosilanes can be favored over the acryl silanes. Suitable vinyl silanes include vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane. Suitable amino organosilanes are described for example in US2006/0147177; incorporated herein by reference.

The inorganic nanoparticle may further comprise various other surface treatments, as known in the art, such as a copolymerizable surface treatment comprising at least one non-volatile monocarboxylic acid having more than six carbon atom or a non-reactive surface treatment comprising a (e.g. polyether) water soluble tail.

To facilitate curing, polymerizable compositions described herein may further comprise at least one free-radical thermal initiator and/or photoinitiator. Typically, if such an initiator and/or photoinitiator are present, it comprises less than about 10 percent by weight, more typically less than about 5 percent of the polymerizable composition, based on the total weight of the polymerizable composition. Free-radical curing techniques are well known in the art and include, for example, thermal curing methods as well as radiation curing methods such as electron beam or ultraviolet radiation. Useful free-radical photoinitiators include, for example, those known as useful in the UV cure of acrylate polymers such as described in WO2006/102383.

The hardcoat composition may optionally comprise various additives. For example, silicone or fluorinated additive may be added to lower the surface energy of the hardcoat.

In one embodiment, the hardcoat coating composition further comprises at least 0.005 and preferably at least 0.01 wt-% solids of one or more perfluoropolyether urethane additives, such as described in U.S. Pat. No. 7,178,264. The total amount of perfluoropolyether urethane additives alone or in combination with other fluorinated additives typically ranges up to 0.5 or 1 wt-% solids.

The perfluoropolyether urethane material is preferably prepared from an isocyanate reactive HFPO- material. Unless otherwise noted, “HFPO-” refers to the end group F(CF(CF₃)CF₂O)ₐCF(CF₃)— of the methyl ester F(CF(CF₃)CF₂O)ₐCF(CF₃)C(O)OCH₃, wherein “a” averages 2 to 15. In some embodiments, a averages between 3 and 10 or a averages between 5 and 8. Such species generally exist as a distribution or mixture of oligomers with a range of values for a, so that the average value of a may be non-integer. For example, in one embodiment, “a” averages 6.2. The molecular weight of the HFPO-perfluoropolyether material varies depending on the number (“a”) of repeat units from about 940 g/mole to about 1600 g/mole, with 1100 g/mole to 1400 g/mole typically being preferred.

In one embodiment, the reaction product comprises a perfluoropolyether urethane additive of the formula:

Rᵢ—(NHC(O)XQR_{f})ₘ,—(NHC(O)OQ(A)ₚ)ₙ;

wherein
Rᵢ is the residue of a multi-isocyanate;
X is O, S or NR, wherein R is H or an alkyl group having 1 to 4 carbon;
R_{f} is a monovalent perfluoropolyether moiety comprising groups of the formula F(R_{fc}O)ₓC_{d}F_{2d}—, wherein each R_{fc} is independently a fluorinated alkylene group having from 1 to 6 carbon atoms, each x is an integer greater than or equal to 2, and wherein d is an integer from 1 to 6;
each Q is independently a connecting group having a valency of at least 2;
A is a (meth)acryl functional group —XC(O)C(R₂)═CH₂ wherein R₂ is an alkyl group of 1 to 4 carbon atoms or H or F;
m is at least 1; n is at least 1; p is 2 to 6; m+n is 2 to 10; wherein each group having subscripts m and n is attached to the Rᵢ unit.

Q in association with the Rf group is a straight chain, branched chain, or cycle-containing connecting group. Q can include an alkylene, an arylene, an aralkylene, an alkarylene. Q can optionally include heteroatoms such as O, N, and S, and combinations thereof. Q can also optionally include a heteroatom-containing functional group such as carbonyl or sulfonyl, and combinations thereof.

When X is O, Q is typically not methylene and thus contains two or more carbon atoms. In some embodiments, X is S or NR. In some embodiments, Q is an alkylene having at least two carbon atoms. In other embodiments, Q is a straight chain, branched chain, or cycle-containing connecting group selected from arylene, aralkylene, and alkarylene. In yet other embodiments, Q contains a heteroatom such as O, N, and S and/or a heteroatom containing functional groups such as carbonyl and sulfonyl. In other embodiments, Q is a branched or cycle-containing alkylene group that optionally contains heteroatoms selected from O, N, S and/or a heteroatom-containing functional group such as carbonyl and sulfonyl. In some embodiments Q contains a nitrogen containing group such an amide group such as —C(O)NHCH₂CH₂—, —C(O)NH(CH₂)₆—, and —C(O)NH(CH₂CH₂O)₂CH₂CH₂—.

If the mole fraction of isocyanate groups is given a value of 1.0, then the total mole fraction of m and n units used in making the perfluoropolyether urethane additive material is 1.0 or greater. The mole fractions of m:n ranges from 0.95:0.05 to 0.05:0.95. Preferably, the mole fractions of m:n are from 0.50:0.50 to 0.05:0.95. More preferably, the mole fractions of m:n are from 0.25:0.75 to 0.05:0.95 and most preferably, the mole fractions of m:n are from 0.25:0.75 to 0.10:0.95. In the instances the mole fractions of m:n total more than one, such as 0.15:0.90, the m unit is reacted onto the isocyanate first, and a slight excess (0.05 mole fraction) of the n units are used.

In a formulation, for instance, in which 0.15 mole fractions of m and 0.85 mole fraction of n units are introduced, a distribution of products is formed in which some fraction of products formed contain no m units.

One representative reaction product formed by the reaction product of a biuret of HDI with one equivalent of HFPO oligomer amidol HFPO-C(O)NHCH₂CH₂OH wherein “a” averages 2 to 15, and further with two equivalents of pentaerythritol triacrylate is shown as follows

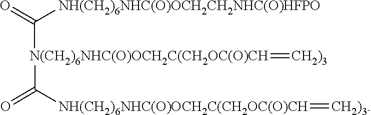

Various other reactants can be included in the preparation of the perfluoropolyether urethane such as described in WO2006/102383 and U.S. Patent Publication No. US2008/0124555, entitled “Polymerizable Composition Comprising Perfluoropolyether Urethane Having Ethylene Oxide Repeat Units”; incorporated herein by reference.

Certain silicone additives have also been found to provide ink repellency in combination with low lint attraction, as described in WO 2009/029438; incorporated herein by reference. Such silicone (meth)acrylate additives generally comprise a polydimethylsiloxane (PDMS) backbone and at least one alkoxy side chain terminating with a (meth)acrylate group. The alkoxy side chain may optionally comprise at least one hydroxyl substituent. Such silicone (meth)acrylate additives are commercially available from various suppliers such as Tego Chemie under the trade designations TEGO Rad 2300 “TEGO Rad 2250”, “TEGO Rad 2300”, “TEGO Rad 2500”, and “TEGO Rad 2700”. Of these, “TEGO Rad 2100” provided the lowest lint attraction.

Based on NMR analysis “TEGO Rad 2100” and “TEGO Rad 2500” are believed to have the following chemical structure:

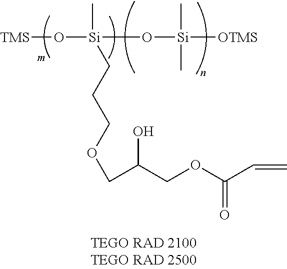

wherein n ranges from 10 to 20 and m ranges from 0.5 to 5.

In some embodiments, n ranges from 14 to 16 and m ranges from 0.9 to 3. The molecular weight typically ranges from about 1000 g/mole to 2500 g/mole.

The silicone (meth)acrylate additive can be added to the hardcoat composition alone or in combination with the perfluoropolyether urethane additive. The concentration of silicone (meth)acrylate additive may range from at least about 0.10, 0.20, 0.30, 0.40, or 0.50 wt-% solids of the hardcoat composition to as much as 1 to 3 wt-% solids of the hardcoat composition.

Based on Thermal Gravimetric Analysis (according to the test method described in the example), silicone (meth)acrylates having a residue content of less than 12 wt-% provided the lowest haze values according to the Cellulose Surface Attraction Test. The surface layers (e.g. comprising such silicone (meth)acrylate additives) preferably have a haze of less than 20%, more preferably less than 10% and even more preferably less than 5% according to the Cellulose Surface Attraction Test.

The cured surface layer and coated articles exhibit “ink repellency” when ink from a pen, commercially available under the trade designation “Sharpie”, beads up into discrete droplets and can be easily removed by wiping the exposed surface with tissues or paper towels, such as tissues available from the Kimberly Clark Corporation, Roswell, Ga. under the trade designation “SURPASS FACIAL TISSUE.”

The polymerizable compositions can be formed by dissolving the free-radically polymerizable material(s) in a compatible organic solvent and then combined with the nanoparticle dispersion at a concentration of about 60 to 70 percent solids. A single organic solvent or a blend of solvents can be employed. Depending on the free-radically polymerizable materials employed, suitable solvents include alcohols such as isopropyl alcohol (IPA) or ethanol; ketones such as methyl ethyl ketone (MEK), methyl isobutyl ketone (MIBK), diisobutyl ketone (DIBK); cyclohexanone, or acetone; aromatic hydrocarbons such as toluene; isophorone; butyrolactone; N-methylpyrrolidone; tetrahydrofuran; esters such as lactates, acetates, including propylene glycol monomethyl ether acetate such as commercially available from 3M under the trade designation “3M Scotchcal Thinner CGS10” (“CGS10”), 2-butoxyethyl acetate such as commercially available from 3M under the trade designation “3M Scotchcal Thinner CGS50” (“CGS50”), diethylene glycol ethyl ether acetate (DE acetate), ethylene glycol butyl ether acetate (EB acetate), dipropylene glycol monomethyl ether acetate (DPMA), iso-alkyl esters such as isohexyl acetate, isoheptyl acetate, isooctyl acetate, isononyl acetate, isodecyl acetate, isododecyl acetate, isotridecyl acetate or other iso-alkyl esters; combinations of these and the like.

The hardcoat composition can be applied as a single or multiple layers to a (e.g. display surface or film) substrate using conventional film application techniques. Thin films can be applied using a variety of techniques, including dip coating, forward and reverse roll coating, wire wound rod coating, and die coating. Die coaters include knife coaters, slot coaters, slide coaters, fluid bearing coaters, slide curtain coaters, drop die curtain coaters, and extrusion coaters among others. Many types of die coaters are described in the literature. Although it is usually convenient for the substrate to be in the form of a roll of continuous web, the coatings may be applied to individual sheets.

The hardcoat composition is dried in an oven to remove the solvent and then cured for example by exposure to ultraviolet radiation using an H-bulb or other lamp at a desired wavelength, preferably in an inert atmosphere (less than 50 parts per million oxygen). The reaction mechanism causes the free-radically polymerizable materials to crosslink.

The thickness of the hardcoat surface layer is typically at least 0.5 microns, 1 micron, or 2 microns. The thickness of the hardcoat layer is generally no greater than 50 microns or 25 microns. Preferably the thickness ranges from about 5 microns to 15 microns.

Due to its optical clarity, the hardcoat described herein is particularly useful for application to light-transmissive film substrates or optical displays. The light transmissive substrate may comprise or consist of any of a wide variety of non-polymeric materials, such as glass, or various thermoplastic and crosslinked polymeric materials, such as polyethylene terephthalate (PET), (e.g. bisphenol A) polycarbonate, cellulose acetate, poly(methyl methacrylate), and polyolefins such as biaxially oriented polypropylene which are commonly used in various optical devices. Further, the substrate may comprise a hybrid material, having both organic and inorganic components. The substrate and cured hardcoat have a transmission of at least 80%, at least 85%, and preferably at least 90%. The initial haze (i.e. prior to abrasion testing) of the substrate and cured hardcoat can be less than 1 or 0.5, or 0.4, or 0.2%.

Various light transmissive optical films are suitable for use as the film substrate including but not limited to, multilayer optical films, microstructured films such as retroreflective sheeting and brightness enhancing films, (e.g. reflective or absorbing) polarizing films, diffusive films, as well as (e.g. biaxial) retarder films and compensator films.

For most applications, the substrate thicknesses is preferably less than about 0.5 mm, and more preferably about 20 microns to about 100, 150, or 200 microns. Self-supporting polymeric films are preferred. The polymeric material can be formed into a film using conventional filmmaking techniques such as by extrusion and optional uniaxial or biaxial orientation of the extruded film. The substrate can be treated to improve adhesion between the substrate and the adjacent layer, e.g., chemical treatment, corona treatment such as air or nitrogen corona, plasma, flame, or actinic radiation. If desired, an optional tie layer or primer can be applied to the protective film or display substrate to increase the interlayer adhesion with the hardcoat.

In order to reduce or eliminate optical fringing it is preferred that the substrate has a refractive index close to that of the hardcoat layer, i.e. differs from the high refractive index layer by less than 0.05, and more preferably less than 0.02. When the substrate has a high refractive index, a high refractive index primer may be use such as a sulfopolyester antistatic primer, as described in US2008/0274352. Alternatively, optical fringing can be eliminated or reduced by providing a primer on the film substrate or illuminated display surface having a refractive index intermediate (i.e. median +/−0.02) between the substrate and the hardcoat layer. Optical fringing can also be eliminated or reduced by roughening the substrate to which the hardcoat is applied. For example the substrate surface may be roughened with a 9 micron to 30 micro microabrasive.

The cured hardcoat layer or film substrate to which the hardcoat is applied may have a gloss or matte surface. Matte films typically have lower transmission and higher haze values than typical gloss films. For examples the haze is generally at least 5%, 6%, 7%, 8%, 9%, or 10% as measured according to ASTM D1003. Whereas gloss surfaces typically have a gloss of at least 130 as measured according to ASTM D 2457-03 at 60°; matte surfaces have a gloss of less than 120.

The hardcoat surface can be roughened or textured to provide a matte surface. This can be accomplished in a variety of ways as known in the art including embossing the hardcoat surface with a suitable tool that has been bead-blasted or otherwise roughened, as well as by curing the composition against a suitable roughened master as described in U.S. Pat. No. 5,175,030 (Lu et al.) and U.S. Pat. No. 5,183,597 (Lu).

Further, various permanent and removable grade adhesive compositions may be provided on the opposite side of the film substrate as the cured hardcoat. For embodiments that employ pressure sensitive adhesive, the protective film article typically includes a removable release liner. During application to a display surface, the release liner is removed so the protective film article can be adhered to the display surface.

Suitable adhesive compositions include (e.g. hydrogenated) block copolymers such as those commercially available from Kraton Polymers, Westhollow, Tex. under the trade designation “Kraton G-1657”, as well as other (e.g. similar) thermoplastic rubbers. Other exemplary adhesives include acrylic-based, urethane-based, silicone-based and epoxy-based adhesives. Preferred adhesives are of sufficient optical quality and light stability such that the adhesive does not yellow with time or upon weather exposure so as to degrade the viewing quality of the optical display. The adhesive can be applied using a variety of known coating techniques such as transfer coating, knife coating, spin coating, die coating and the like. Exemplary adhesives are described in U.S. Patent Application Publication No. 2003/0012936. Several of such adhesives are commercially available from 3M Company, St. Paul, Minn. under the trade designations 8141, 8142, and 8161.

The hardcoat described herein or a protective film can be employed with a variety of portable and non-portable information display articles. The displays include various illuminated and non-illuminated displays articles. Such displays include multi-character and especially multi-line multi-character displays such as liquid crystal displays (“LCDs”), plasma displays, front and rear projection displays, cathode ray tubes (“CRTs”), signage, as well as single-character or binary displays such as light emitting tubes (“LEDs”), signal lamps and switches.

Illuminated display articles include, but are not limited to, PDAs, LCD-TV's (both edge-lit and direct-lit), cell phones (including combination PDA/cell phones), touch sensitive screens, wrist watches, car navigation systems, global positioning systems, depth finders, calculators, electronic books, CD and DVD players, projection televisions screens, computer monitors, notebook computer displays, instrument gauges, and instrument panel covers. These devices can have planar or curved viewing faces. In a favored embodiment, the hardcoat or protective film comprising such can be used in place of a cover glass used to protect the touch screen from becoming scratched.

In one embodiment, the protective film or cured hardcoat (e.g. applied to a glass substrate), as described herein, is a surface layer of a touch screen, or a component there such as a touch sensor film substrate or a touch module comprising an assembly of touch sensor substrates.

A touch screen is generally a component of a computer display screen that enables sensitivity to human touch, allowing a user to interact with the computer by touching the screen. A touch screen can include multiple touch sensor substrates and optionally a cover glass or a cover film. A touch screen can also be referred to as a touch module. There are several types of touch screens. Alternatives to projected capacitive (i.e. non-projected capacitive) touch screens include resistive touch screen, digital resistive touch screen, surface acoustic touch screen, surface capacitive touch screen, and inductive touch screen.

A projected capacitive touch screen panel is coated with a material that transports electrical charges. A projected capacitive touch screen can be patterned with a plurality of conductive electrodes. When the panel is touched, a small amount of charge is drawn along the electrodes to the point of contact. Circuits connected to each of the electrodes measure the charge and send the information to the controller for processing. Various projected capacitive touch screen are known. Example of touch screens include those described in U.S. Pat. No. 7,030,860; U.S. Pat. No. 7,463,246; U.S. Pat. No. 7,663,607; U.S. Pat. No. 7,932,898; U.S. Pat. No. 8,179,381; U.S. Pat. No. 8,243,027; US 2008/0266273; and US 2012/0256878; each of which are incorporated herein by reference.

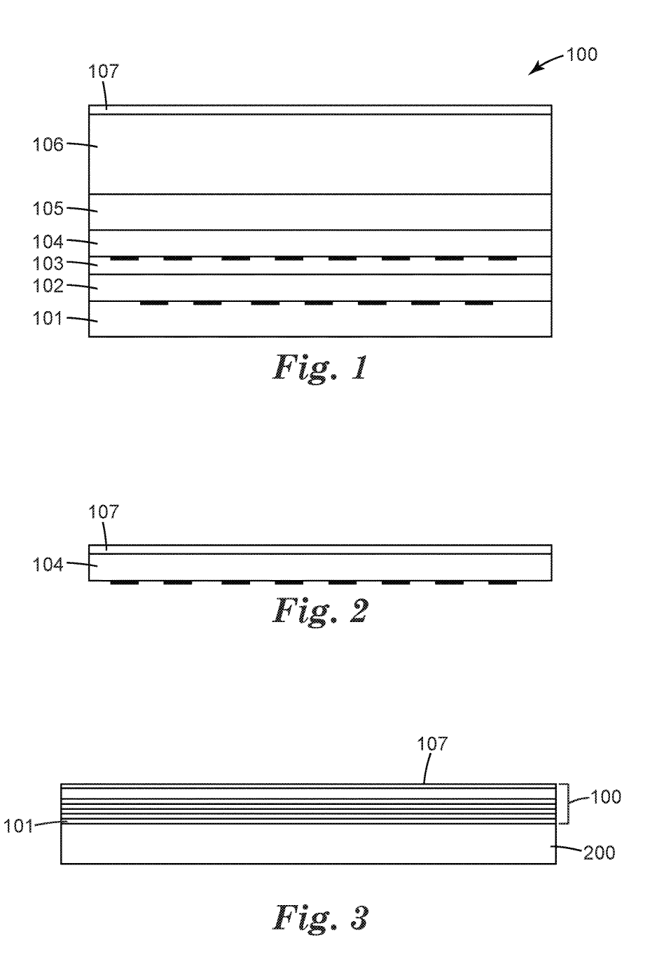

In one embodiment, a touch sensor film substrate is described comprising a set of patterned electrode and a cured hardcoat or protective film comprising the cured hardcoat disposed on the touch sensor film substrate such that the cured hardcoat forms a protective surface layer. With reference to FIG. 1, the touch sensor film substrate 104 having a set of patterned electrodes (such as described U.S. Pat. No. 8,179,381) may be bonded (with an optically clear adhesive 105) to protective film substrate 106 including hardcoat 107. Alternatively, 106 may be a glass substrate.

In another embodiment, hardcoat 107 may be disposed directly on touch sensor film substrate 104, as depicted in FIG. 2.

In another embodiment, a touch screen is described comprising a pair of touch sensor film substrates. With reference to FIG. 1, touch screen 100 comprises a second sensor film substrate 102 having a set of patterned electrodes (such as described U.S. Pat. No. 8,179,381) bonded (with an optically clear adhesive 103) to the first sensor film substrate 104. Touch sensor film substrate 104 may be bonded (with an optically clear adhesive 105) to protective film substrate 106 including hardcoat 107. In another embodiment, touch sensor film substrate 104 may be bonded (with an optically clear adhesive 105) to glass (not shown) in place of protective film substrate 106 including hardcoat 107. In yet another embodiment, hardcoat 107 may be disposed directly on touch sensor film substrate 104, as depicted in FIG. 2 (wherein layers 105 and 106 are absent).

The display article comprises touch screen 100 bonded to illuminated display 200 (with optically clear adhesive 101), as depicted in FIG. 3. Non-illuminated display articles include, but are not limited to. (e.g. retroreflective) signage and commercial graphic display films employed for various advertising, promotional, and corporate identity uses.

The hardcoat material can be employed on a variety of other articles as well such as for example camera lenses, eyeglass lenses, binocular lenses, mirrors, automobile windows, building windows, train windows, boat windows, aircraft windows, vehicle headlamps and taillights, display cases, eyeglasses, overhead projectors, stereo cabinet doors, stereo covers, watch covers, as well as optical and magneto-optical recording disks, and the like.

While the invention has been described in terms of preferred embodiments, it will be understood, of course, that the invention is not limited thereto since modifications may be made by those skilled in the art, particularly in light of the foregoing teachings.

### Components Utilized in the Examples

Esacure One is a photoinitiator and is available from Lamberti USA (Conshohocken Pa.). SR399 from Sartomer USA (Exton Pa.) is a dipentaerythritol pentaacrylate resin.

The perfluoropolyether urethane multi-acrylate was prepared according to the procedure outlined in U.S. Pat. No. 7,178,264, Preparation No. 6 (Preparation of Des N100/0.90 PET3A/0.15 HFPO), with the following exceptions: The molar ratios of materials used were adjusted to 1.0 Des N100/0.95 PET3A/0.10 HFPO; the HFPO amidol was added over about 30 minutes instead of all at once at the beginning of the reaction; and the reaction was run at 66% solids in acetone instead of at 50% solids in methyl ethyl ketone.

SR9035 from Sartomer USA is an ethoxylated (15) trimethylolpropane triacrylate, reported to have a molecular weight of 956 g/mole.

SR415, also from Sartomer USA, is an ethoxylated (20) trimethylolpropane triacrylate, reported to have a molecular weight of 1176 g/mole.

SR502 from Sartomer USA is an ethoxylated (9) trimethylolpropane triacrylate, reported to have a molecular weight of 692 g/mole.

SR501, also from Sartomer USA, is a propoxylated (6) trimethylolpropane triacrylate reported to have a molecular weight of 645 g/mole.

Both 1-methoxy-2-propanol and 2-butanone were obtained from Sigma-Aldrich (Milwaukee Wis.). SR344 from Sartomer USA is a polyethylene glycol (400) diacrylate.

SR610 from Sartomer USA is a polyethylene glycol (600) diacrylate.

Byk 3610 is a 37 wt-% solids aluminum oxide (20 nm) dispersion in methoxypropyl acetate from BYK

### Additives and Instruments

Silica nanoparticle dispersion A was prepared as follows. A 1000 ml 3-neck flask equipped with a stir bar, stir plate, condenser, heating mantle and thermocouple/temperature controller was charged with 300 grams of Nalco 2329K (a 40 wt % solids dispersion of approximately 75 nm diameter colloidal silica in water available from Nalco Chemical Company, Naperville Ill.). To this dispersion, 350 grams of 1-methoxy-2-propanol was added with stirring. Next 5.03 grams of 97% 3-(methacryloxypropyl)trimethoxysilane (available from Alfa Aesar, Ward Hill Mass., Stock #A17714), 0.30 grams of a 5% aqueous solution of Prostab 5198 (available from BASF Corp., Florham Park N.J.) and 50 grams of 1-methoxy-2-propanol was added to a 100 ml poly beaker. The premix of 3-(methacryloxypropyl)trimethoxysilane/Prostab 5198/1-methoxy-2-propanol premix was added to the batch with stirring. The beaker containing the premix was rinsed with aliquots of 1-methoxy-2-propanol totaling 50 grams. The rinses were added to the batch. At this point the batch was a translucent, low-viscosity dispersion. The batch was heated to 80° C. and held for approximately 16 hours. The batch was cooled to room temperature and transferred to a 2000 ml 1-neck flask. The reaction flask was rinsed with 100 grams of 1-methoxy-2-propanol and the rinse was added to the batch. An additional 250 grams of 1-methoxy-2-propanol was added to the flask to aid in the 1-methoxy-2-propanol/water azeotrope distillation. The batch was heated/distilled under vacuum on a Rotavapor to result in a translucent dispersion containing 42 wt % solids of surface-modified silica particles in 1-methoxy-2-propanol.

Silica nanoparticle dispersion B was prepared as follows: A 1000 ml 3-neck flask equipped with a stir bar, stir plate, condenser, heating mantle and thermocouple/temperature controller was charged with 300 grams of Nalco 2327 (a 40 wt % solids dispersion of approximately 20 nm diameter colloidal silica in water available from Nalco Chemical Company, Naperville Ill.). To this dispersion, 350 grams of 1-methoxy-2-propanol was added with stirring. Next 18.45 grams of 97% 3-(methacryloxypropyl)trimethoxysilane (available from Alfa Aesar, Ward Hill Mass., Stock #A17714), 0.30 grams of a 5% aqueous solution of Prostab 5198 (available from BASF Corp., Florham Park N.J.) and 50 grams of 1-methoxy-2-propanol was added to a 100 ml poly beaker. The premix of 3-(methacryloxypropyl)trimethoxysilane/Prostab 5198/1-methoxy-2-propanol premix was added to the batch with stirring. The beaker containing the premix was rinsed with aliquots of 1-methoxy-2-propanol totaling 50 grams. The rinses were added to the batch. At this point the batch was a translucent, low-viscosity dispersion. The batch was heated to 80° C. and held for approximately 16 hours. The batch was cooled to room temperature and transferred to a 2000 ml 1-neck flask. The reaction flask was rinsed with 100 grams of 1-methoxy-2-propanol and the rinse was added to the batch. An additional 250 grams of 1-methoxy-2-propanol was added to the flask to aid in the 1-methoxy-2-propanol/water azeotrope distillation. The batch was heated/distilled under vacuum on a Rotavapor to result in a translucent dispersion containing 42 wt % solids of surface-modified silica particles in 1-methoxy-2-propanol.

Propoxylated glycerol triacrylate A was prepared as follows: A 500 mL round bottom flask was equipped with a mechanical stirrer, temperature probe, Dean-Stark trap and condenser. To this flask were charged the following reactants: 50 grams of Acclaim Polyol 703 (Bayer Materials Science, Pittsburgh, Pa., a 700 molecular weight polypropylene oxide based triol) (0.64 moles), 15.4 grams of acrylic acid (0.21 moles), 150 grams of toluene, 2.0 grams of para-toluene sulfonic acid, and 0.11 grams of 4-hydroxy TEMPO. The reagents were heated to azeotrope the toluene solvent and the water generated in the esterification. The solution was then held for 16 hours and cooled to room temperature. Then 100 grams of ethyl acetate and a mixture of 100 grams of water and 10 grams of sodium bicarbonate were added to the solution. The flask was then shaken and the solution was phase split in a separatory funnel. To refine the phase splits, 100 grams of ethyl acetate and 10 grams of isopropanol were added first, then the lower aqueous phase was removed, and then 100 grams of saturated brine solution was added to the organic phase. The resulting solution was held for several hours. Then the aqueous phase was removed and the organic phase was dried over magnesium sulfate, filtered and the solvent was stripped using a rotary evaporator.

Propoxylated glycerol triacrylate B was prepared as with the A version except that 50 grams (0.33 moles) of Arcol Polyol F-1522 (Bayer Materials Science, Pittsburgh, Pa., a 1500 molecular weight polypropylene oxide based triol), 7.7 grams (0.11 moles) of acrylic acid, 1.0 grams of para-toluene sulfonic acid, and 0.06 grams of 4-hydroxy TEMPO were used as reagents.

The components were combined and mixed according to Tables 1A & 1B to produce various (reactive mixture) coating solutions. The quantities in Table 1A & 1B are all parts by weight.

TABLE 1A
Components of reaction mixture

| | Sam- | Sam- | Sam- | Sam- | Sam- |
|---|---|---|---|---|---|
| Component | ple 1 | ple 2 | ple 3 | ple 4 | ple 5 |
| Esacure One | 1.84 | 1.84 | 1.84 | 1.84 | 1.84 |
| SR 399 | 16.1 | 16.1 | 16.1 | 16.1 | 16.1 |
| Perfluoropolyether | 0.012 | 0.012 | 0.012 | 0.012 | 0.012 |
| urethane multi- | | | | | |
| acrylate | | | | | |
| Silica nanoparticle | 58.7 | 58.7 | 58.7 | 58.7 | 58.7 |
| dispersion A | | | | | |
| Propoxylated glycerol | 9.23 | | | | |
| triacrylate A | | | | | |
| Propoxylated glycerol | | 9.23 | | | |
| triacrylate B | | | | | |
| SR9035 | | | 9.23 | | |
| SR415 | | | | 9.23 | |
| SR502 | | | | | 9.23 |
| 2-butanone | 13.8 | 13.8 | 13.8 | 13.8 | 13.8 |

TABLE 1B
Components of reaction mixture

| | Sam- | Sam- | Sam- | Sam- | Sam- |
|---|---|---|---|---|---|
| Component | ple 6 | ple 7 | ple 8 | ple 9 | ple 10 |
| Esacure One | 1.84 | 1.84 | 1.84 | 1.84 | 1.84 |
| SR 399 | 16.1 | 16.1 | 16.1 | 16.1 | 16.1 |
| Perfluoropolyether | 0.012 | 0.012 | 0.012 | 0.012 | 0.012 |
| urethane multi- | | | | | |
| acrylate | | | | | |
| Silica nanoparticle | 58.7 | 58.7 | 58.7 | | 55.9 |
| dispersion A | | | | | |
| Silica nanoparticle | | | | 58.7 | |
| dispersion B | | | | | |
| Byk 3610 | | | | | 3.73 |
| SR501 | 9.23 | | | | |
| SR344 | | 9.23 | | | |
| SR610 | | | 9.23 | | |
| SR9035 | | | | 9.23 | 9.23 |
| 2-butanone | 13.8 | 13.8 | 13.8 | 13.8 | 13.8 |

The prepared coating solutions were coated at 52% solids to 5 mil (0.13 mm) primed PET (available as ScotchPak from 3M Company, St. Paul Minn.) The coating was done with a #18 wire wound rod (available from R.D. Specialties, Webster N.Y.) and dried at 80° C. for 2 minutes. The dried coating had a thickness of about 10 microns. The coatings were then cured using a Light Hammer 6 UV source with a Fusion H bulb (both available from Fusion UV Systems, Gaithersburg Md.) at 100% power under nitrogen at 30 feet/minute (9.1 m/min). The wt-% solids of each of the components of the cured hardcoat composition were calculated as set forth in following Tables 2A and 2B.

TABLE 2A
Weight % of reaction mixture solids

| | Sam- | Sam- | Sam- | Sam- | Sam- |
|---|---|---|---|---|---|
| | ple 1 | ple 2 | ple 3 | ple 4 | ple 5 |
| Esacure One | 3.55 | 3.55 | 3.55 | 3.55 | 3.55 |
| SR 399 | 31.1 | 31.1 | 31.1 | 31.1 | 31.1 |
| Perfluoropolyether | .015 | .015 | .015 | .015 | .015 |
| urethane multi- | | | | | |
| acrylate | | | | | |
| Solids of Dispersion A | 47.53 | 47.53 | 47.53 | 47.53 | 47.53 |
| silica/3-(methacryloxy- | (45.96/ | (45.96/ | (45.96/ | (45.96/ | (45.96/ |
| propyl) | 1.57) | 1.57) | 1.57) | 1.57) | 1.57) |
| trimethoxysilane | | | | | |
| Propoxylated glycerol | 17.8 | | | | |
| triacrylate A | | | | | |
| Propoxylated glycerol | | 17.8 | | | |
| triacrylate B | | | | | |
| SR9035 | | | 17.8 | | |
| SR415 | | | | 17.8 | |
| SR502 | | | | | 17.8 |

TABLE 2B
Weight % of reaction mixture solids

| | Sam- | Sam- | Sam- | Sam- | Sam- |
|---|---|---|---|---|---|
| | ple 6 | ple 7 | ple 8 | ple 9 | ple 10 |
| Esacure One | 3.55 | 3.55 | 3.55 | 3.55 | 3.55 |
| SR 399 | 31.1 | 31.1 | 31.1 | 31.1 | 31.1 |
| Perfluoropolyether | .015 | .015 | .015 | .015 | .015 |
| urethane multi- | | | | | |
| acrylate | | | | | |
| Solids of Dispersion A | 47.53 | 47.53 | 47.53 | | 45.23 |
| silica/3-(methacryloxy- | (45.96/ | (45.96/ | (45.96/ | | (43.7/ |
| propyl) | 1.57) | 1.57) | 1.57) | | 1.49) |
| trimethoxysilane | | | | | |
| Solids of Dispersion B | | | | 47.53 | |
| silica/3-(methacryloxy- | | | | (42.3/ | |
| propyl) | | | | 5.23) | |
| trimethoxysilane | | | | | |
| Byk 3610 | | | | | 2.66 |
| (aluminum oxide/ | | | | | (2.16/ |
| dispersant) | | | | | 0.50) |
| SR501 | 17.8 | | | | |
| SR344 | | 17.8 | | | |
| SR610 | | | 17.8 | | |
| SR9035 | | | | 17.8 | 17.8 |

The coated samples were then evaluated using an abrasion test and a pencil hardness test.

Abrasion resistance of the samples was tested cross web to the coating direction using a mechanical device capable of oscillating an abrasive material adhered to a stylus across each sample's coated surface. The stylus oscillated over a 60 mm wide sweep width at a rate of 210 mm/sec (3.5 wipes/second), where a wipe is defined as a single travel of 60 mm. The stylus was a cylinder with a flat base and a diameter of 3.2 cm. The abrasive material used for this test was a 3M Scotch Bright heavy duty scouring pad (available from 3M Company, St. Paul Minn.). Disks of diameter 3.2 cm were cut from the pads and adhered to the base of the stylus using 3M Scotch Permanent Adhesive Transfer tape. A single sample was tested for each example with a 1 kg weight and 150 wipes.

After abrasion, the optical haze of each sample was measured using a Haze-Gard Plus haze meter (available from BYK Gardner, Columbia Md.) at five different points. The average haze value for each sample is reported in Table 2.

Pencil hardness of each sample was measured using the JIS K5600 test procedure and a #7H pencil and a 750 g weight. Using a microscope at 50× magnification each sample was examined to determine if there was any cracking had been induced. A “Pass” recorded in Table 2 indicates that no cracking was seen. A “Fail” indicates that evidence of cracking was observed.

TABLE 3
Test Results

| | Molecular weight | | Abrasion | |
|---|---|---|---|---|
| | per acrylate of | Pencil | test | |
| | Alkoxy Multi- | hardness | Average | Initial |
| | acrylate | test | haze | Haze |
| Example 1 | 304 | Pass | 2.7% | 0.2 |
| (propoxylated | | | | |
| glycerol | | | | |
| triacrylate A) | | | | |
| Comparative | 554 | Fail | 2.4% | 0.3 |
| Example 2 | | | | |
| (propoxylated | | | | |
| glycerol | | | | |
| triacrylate B) | | | | |
| Example 3 (SR9035) | 319 | Pass | 2.2% | 0.2 |
| Comparative | 392 | Fail | 1.7% | 0.2 |
| Example 4 (SR415) | | | | |
| Example 5 (SR502) | 231 | Pass | 1.3% | 0.15 |
| Comparative | 215 | Fail | 4.4% | 0.15 |
| Example 6 (SR501) | | | | |
| Comparative | 254 | Fail | 0.9% | 0.2 |
| Example 7 (SR344 | | | | |
| diacrylate) | | | | |
| Comparative | 371 | Fail | 1.3% | 0.3 |
| Example 8 (SR610 | | | | |
| diacrylate) | | | | |
| Comparative | 319 | Fail | 2.2% | 0.15 |
| Example 9 (SR9035) | | | | |
| Example 10 (SR9035) | 319 | Pass | 3.7% | 0.3 |

### EXAMPLE 11

A touch screen 100 was prepared as follows. The bottom layer 101 was an optional optically clear adhesive (3M 2506, an acrylic adhesive available from 3M Company, St. Paul Minn.), 6 mils thick. Immediately above this was touch sensor film substrate 102 (Melinex ST504 PET, 5 mils thick, available from DuPont Teijin Films US, Chester Va.) with a set of patterned electrodes as previously described in Example 41 of U.S. Pat. No. 8,179, 381 (Frey et al.) on the down facing side of the film. Above this was a 2 mil thick layer of an optically clear adhesive 103 (3M 8146 Optically Clear Adhesive, also available from 3M Company). Above the adhesive was another touch sensor film substrate 104 including another set of patterned electrodes, as previously described. The electrodes of the two sensor film substrates created an electrode matrix with nodes where the sets of electrodes from the two films intersected. The layer above this was protective film substrate 106 (Melinex 618 PET, 10 mils thick, also available from DuPont Teijin) coated on the bottom side with optically clear adhesive 105 (3M 8146 Optically Clear Adhesive) at a 4 mil thickness. Coated on the upper side of the protective film substrate at a 12 micron thickness was the hard coat 107 of the current invention. The layers in this stack were then laminated together as described in U.S. Pat. No. 8,179, 381 to create touch screen 100. The assembled layers of touch screen 100 are shown in FIG. 1. A display comprising touch screen 100 bonded to illuminated display 200 is shown in FIG. 2.

What is claimed is:

1. A hardcoat composition comprising:
at least one first (meth)acrylate monomer comprising at least three (meth)acrylate groups and C₂-C₄ alkoxy repeat units wherein the monomer has a molecular weight per (meth)acrylate group ranging from about 220 to 375 g/mole;
at least one second (meth)acrylate monomer comprising at least three (meth)acrylate groups; and
at least 50 wt-% solids of silica nanoparticles;
wherein the cured hardcoat at a thickness of 10 microns exhibits no cracking when tested with a #7H pencil and a 750 gram weight.

2. The hardcoat composition of claim 1 wherein the hardcoat composition comprises at least 40 wt-% solids of silica nanoparticles having an average particle size ranging from 50 to 150 nm.

3. The hardcoat composition of claim 1 wherein the hardcoat composition comprises up to 10 wt-% solids of the silica nanoparticles having an average particle size less than 50 nm.

4. The hardcoat composition of claim 1 wherein the silica nanoparticles are present in an amount ranging up to 60 wt-% solids.

5. The hardcoat composition of claim 1 wherein the at least one first (meth)acrylate monomer is present in an amount ranging from 10 to 30 wt-% solids of the hardcoat composition.

6. The hardcoat composition of claim 1 wherein the at least one second (meth)acrylate monomer is present in an amount ranging from 25 wt-% to 50 wt-% solids of the hardcoat composition.

7. The hardcoat composition of claim 6 wherein the at least one second (meth)acrylate monomer comprises at least four (meth)acrylate groups.

8. The hardcoat composition of claim 6 wherein the at least one second (meth)acrylate monomer is free of C₂-C₄ alkoxy repeat units.

9. The hardcoat composition of claim 1 wherein the hardcoat composition further comprises a fluorinated or silicone additive.

10. A protective film article comprising a light transmissive polymeric film and the cured hardcoat composition of claim 1.

11. A display article comprising a light-transmissive surface wherein the surface comprises the protective film of claim 10.

12. A display article comprising a light-transmissive surface wherein the surface comprises the cured hardcoat of claim 1.

13. The display article of claim 12 wherein the display article is an illuminated display.

14. The protective film article of claim 10 further comprising a primer layer disposed between the light transmissive polymeric film and the cured hardcoat composition.

15. The display article of claim 12 wherein the display article comprises a touch screen.

16. A touch screen or touch sensor substrate comprising the protective film of claim 10.

17. A touch screen or touch sensor substrate comprising the cured hardcoat of claim 1.

18. The display article of claim 12 further comprising a primer layer disposed between the light transmissive polymeric film and the cured hardcoat composition.
